(19) United States
(12) Patent Application Publication
(10) Pub. No.: US 2021/0406294 A1
(43) Pub. Date: Dec. 30, 2021

(54) RELEVANCE APPROXIMATION OF PASSAGE EVIDENCE

(71) Applicant: International Business Machines Corporation, Armonk, NY (US)

(72) Inventors: Dwi Sianto Mansjur, Cary, NC (US); Scott Carrier, New Hill, NC (US); BRENDAN BULL, Durham, NC (US); Paul Lewis Felt, Springville, UT (US)

(21) Appl. No.: 16/910,159

(22) Filed: Jun. 24, 2020

(51) Int. Cl. G06F 16/33; G06N 20/00; G06F 16/338; G06F 16/38; G06F 16/35

(52) U.S. Cl. CPC G06F 16/3344; G06N 20/00; G06F 16/35; G06F 16/38; G06F 16/338

(57) ABSTRACT

Aspects of the invention include receiving a search query from a user computing device. Retrieving a set of passages based on the search query, wherein each passage contains passage evidence and an annotation embedded as metadata. Scoring each annotation and each passage evidence, where each annotation score is based on a feature vector of the annotation and the search query, and where each passage evidence score is based on a feature vector of the passage evidence and the search query. Ranking each passage based on a passage evidence score and a score of one annotation contained in the passage. Returning a ranked list of each passage to the user computing device.

### BACKGROUND

The present invention generally relates to programmable computing systems, and more specifically, to relevance approximation of passage evidence.

Computer information systems can receive search queries from a user and provide answers back to the user. In information retrieval, a question answering (QA) system is tasked with automatically answering a question posed in natural language to the system. A QA system can find an answer by analyzing a search query using NLP techniques and retrieve an answer from either a pre-structured database or a collection of documents, such as a data corpus or a local database. QA systems occasionally produce failures in executing their tasks, such as providing an incorrect answer response to question inputs. As a result, in order to enhance the efficiency and utility of QA systems, solutions are required to address these failures adequately.

### SUMMARY

Embodiments of the present invention are directed to relevance approximation of passage evidence. A non-limiting example computer-implemented method includes Retrieving a set of passages in response to the search query, wherein each passage contains passage evidence and an annotation embedded as metadata. Scoring each annotation and each passage evidence, where each annotation score is based on a feature vector of the annotation and the search query, and where each passage evidence score is based on a feature vector of the passage evidence and the search query. Ranking each passage based on a passage evidence score and a score of one annotation contained in the passage. Returning a ranked list of each passage to the user computing device.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a block diagram of components of a system for annotation-based passage scoring in accordance with one or more embodiments of the present invention;

FIG. 2A illustrates a table of annotation rankings using two different machine learning models in accordance with one or more embodiments of the present invention;

FIG. 2B illustrates a pairwise agreement matrix for ranking annotations in accordance with one or more embodiments of the present invention;

FIG. 3 illustrates a passage and annotations in accordance with one or more embodiments of the present invention;

FIG. 4 illustrates a flow diagram of a process for annotation-based passage scoring in accordance with one or more embodiments of the present invention;

FIG. 5 depicts a cloud computing environment according to one or more embodiments of the present invention;

FIG. 6 depicts abstraction model layers according to one or more embodiments of the present invention; and

FIG. 7 depicts a block diagram of a computer system for use in implementing one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provide computing systems and computer-implemented methods for receiving a set of candidate passages in response to a search query from a user. The candidate passages are scored based on a combination of passage text scoring and passage annotation in relation to the search query. The results are ranked based on the scoring and provided back to the user.

A conventional question answer (QA) computing system can receive a search query from an end-user computing device. Based on the search query, the QA computing system retrieves an initial set of passages (documents) from a knowledge base. The passages are analyzed using a variety of techniques, and the QA system generates a list of candidate answer passages. The QA system transmits the ranked list of candidate answer passages back to the end-user computing device. The quality of the answer passages, therefore, depends upon the accuracy of the ranking process. However, the selection of annotations for passages is subjective, and the best annotation may not have been chosen for a passage. The conventional techniques do not account for lower quality annotations, which lead to a poor ranking of passages. An inaccurate ranking of passages results in a poor set of answer passages being transmitted to the end-user computing device.

One or more embodiments of the present invention address one or more of the above-described shortcomings by providing computer implement methods and systems that generate distinct scores for passages and associated annotations. The final ranking of passages is determined not only of the passage score, but a ranking of annotation score in relation to each other. Therefore, if an annotation scores below other annotations, it will result in a reduction of the overall passage score. This will result in higher quality passages being returned to the user.

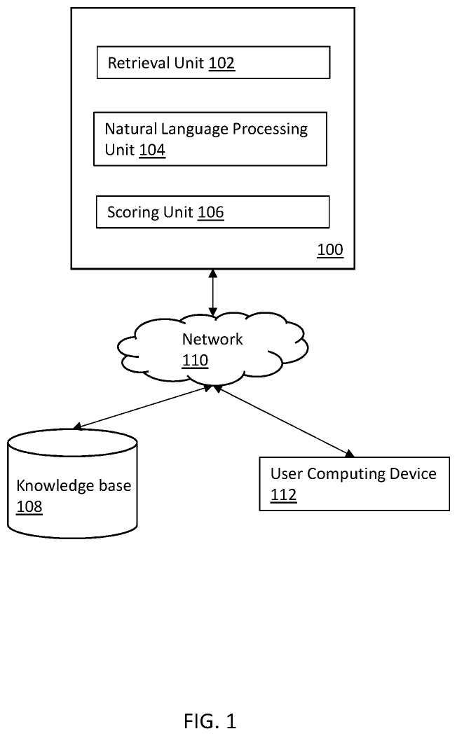

Turning now to FIG. 1, a system 100 for passage approximation of passage evidence is generally shown in accordance with one or more embodiments of the present invention. The system 100 includes a retrieval unit 102 for retrieving documents in response to a search query from a user. The system 100 further includes a natural language processing (NLP) unit 104 for analyzing the text of retrieved documents and any annotations associated with the passages. The NLP unit 104 can further segment the documents into passages for scoring purposes. Finally, the system 100 includes a scoring unit 106 for scoring the passages and annotations in relation to the search query and generating a ranked list of passages to return to the user. The system 100 is in operable communication with and can retrieve passages from a database, corpus/knowledge base 108 via a communication network 110. The system 100 is also in operable communication with a user computing device 112 via the network 110.

The retrieval unit 102 can receive a search query from a user. A search query is a string text entered by a user in order to receive a set of results. The retrieval unit 102 can use various methods such as computational linguistics, information retrieval, and knowledge representation to analyze the search query and generate a set of documents in response to the search query. In general, the retrieval unit 102 can receive a search query as natural language and determine the context of the search query. This process can be performed by extracting keywords and applying natural language processing techniques (NLP) to semantically analyze the search query. The process results in determining the question type, target answer type, and focus/subject matter of the search query. Once the retrieval unit 102 determines the subject and question type, it can retrieve relevant documents from a database 108 based on keywords in the search query. For example, a user may enter the search query: “treatments for diabetes” and the retrieval unit 102 can determine that the user is asking for treatments for diabetes. Based on this determination, the retrieval unit 102 and search the Unified Medical Language System (UMLS) 108 and retrieve documents that potentially answer the user's question.

The NLP unit 104 can receive the documents from the retrieval unit 102 and apply NLP techniques to segment the documents into passages. Passages that the retrieved documents can be segmented into include topics, paragraphs, sentences, bullet points, and other units. The NLP unit 104 can segment a document based on punctuation or spacing, or apply statistical models, dictionaries, and consider syntactic and semantic construction.

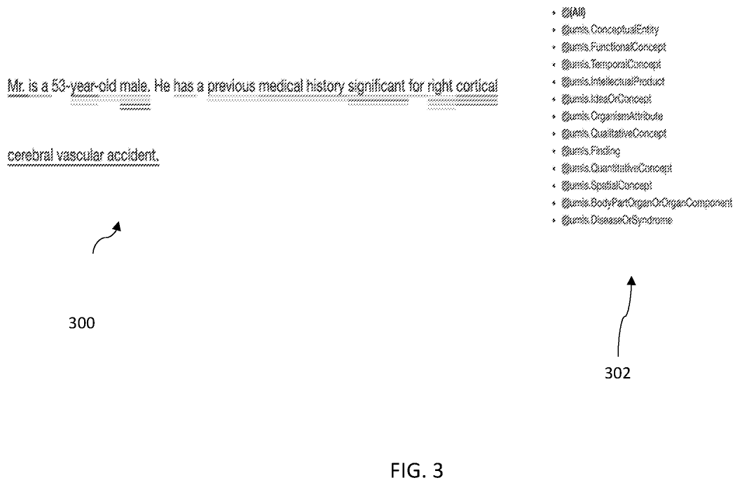

The scoring unit 106 receives the passages from NLP unit 104. The scoring unit 106 can include a neural network and generate a score for each associated annotation based on a relevance to the search query. Annotations are metadata associated with tokens in a passage. For example, a user may enter the phrase, “What can I take for diabetes?”. The token “diabetes” can be annotated as a “medicalcondition”. In response, a system may retrieve a passage that includes a phrase, “The prescription for diabetes is drugX”. The token “drugX” can be annotated to reflect an overall entity. In this example, for “drugX”, the associated entity annotation can be “drug”. An annotation may also describe a relationship between two or more tokens. For example, in the above sentence, an annotation “treatmentfor” can describe a relationship between the tokens “diabetes” and “drugX”. In this example, “drugX” is the evidence that answers the question. The scoring unit 106 can score use as inputs, each annotation for a trained model and output a score that is relative to the search query. The passages can be scored based on various factors such as a relation to keywords in the search query, closeness to topics in the search query, or other appropriate factor. The annotation score for each annotation in a passage can be used to populate a respective annotation feature vector for each annotation in the passage. Referring to FIG. 3, a passage 300 and set of annotations 302 associated with respective tokens in the passage is depicted for illustrative purposes.

The scoring unit 106 also scores the segmented passages received from the NLP unit 104. The scoring unit 106 approximates the passage scores with respect to the search query. To score the passages, the scoring unit 106 extracts evidence from the passages. Passage evidence is snippets of information in the passages that assist in answering the search query. The evidence can include answer type match, pattern matches, keyword matches, a numerical distance in a value of a keyword and word in a passage, punctuation, sequencing of words, and any other appropriate feature. The scoring unit 106 can score each piece of evidence using a trained machine learning model and output a score that is relative to the search query. The passages can further be scored based on a credibility of the passage source, temporal or geospatial relationships between the search query and the passage. The scoring unit 106 can further apply certain metrics, for example, how does the passage compare with a ground truth passage. The passage score can be used to populate a respective passage feature vector for each passage in a document.

The scoring unit 106 combines the annotation score with passage score to determine a ranking of each passage to return to the user. The scoring unit 106 can sort the passages based on scores and return the documents containing the k-highest passages to the user. The k value can be pre-determined by an administrator. For example, if the k value is ten, the scoring unit 106 can return the ten highest scoring documents from a larger set of retrieved documents. In some embodiments of the present invention, the passage score in relation to the search query q score can be calculated using the following equation:

score(e;q):=αscore_{E}_{_{ML}}(e)+(1−α)max_{α∈e} score_{A}_{_{ML}}(a),

where e is passage evidence, α is a free parameter, score_{E}_{_{ML}}(e) is the passage score, and score_{A}_{_{ML}}(a) is the annotation score. A conventional question and answer system ranks passages based on passage scoring. The herein described methods and systems rank passages based on passage scoring and a relative annotation scoring. The free parameter a is determined empirically and prevents the annotation score from overpowering the passage score. Therefore, if the evidence e results in a high ranking for a passage, the passage remains highly ranked as long as one of the passage's annotations is ranked high. This method utilizes only the highest scored annotation of a passage to assign a final passage score. The higher a passage a ranked, the better the scoring unit 106 considers the passage as a good candidate answer for the search query. The annotation and passage scores can be represented as follows:

$$s c o r {e}_{{E}_{M L} ( d )} \frac{- 1}{v + s c o r {e}_{{E}_{M L} ( d )}} , and$$

$$scor {e}_{{A}_{M L} ( d )} \frac{- 1}{v + s c o r {e}_{{A}_{M L} ( s )}} ,$$

where v is a free parameter and the score is the inverse of the rank.

In another embodiment of the present invention, the scoring unit 106 applies a statistical approach to ranking passages. In one instance, a feature vector used to represent a search query document pair is as follows:

v^{(MARS)}(e,q)=v_{(e,q)}(exclusive)v′_{(e,q)},

where v^{(MARS)}(e, q) is the concatenation of v_{(e,q)} and v′_{(e,q)}. v_{(e,q)} is the original feature vector used by a machine learning algorithm to generate the passage ranking. v′_{(e,q)} is a feature vector composed of annotation-based estimates (i.e. maximum, minimum, average, standard deviation of score_{A}_{_{ML}} for the percentage of annotation in which the passage evidence score is a member of the set of passage scores.

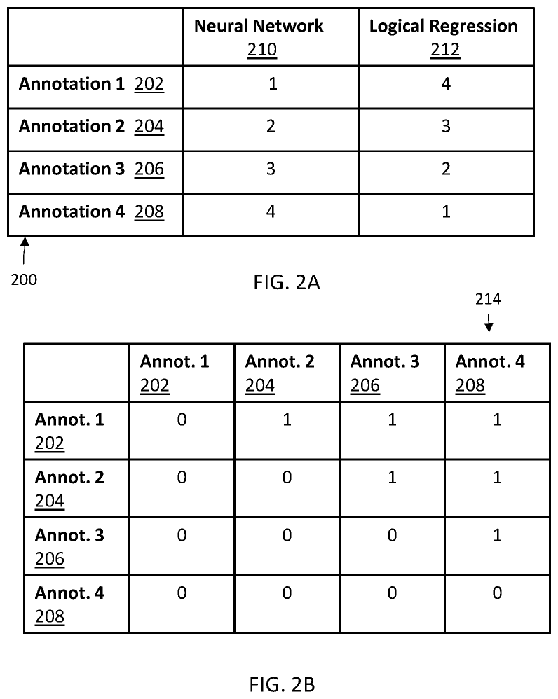

The scoring unit 106 uses the annotation scores to develop a ranking of the annotations. Referring to FIG. 2A a table 200 representing the ranking of the annotation in relation to a search query is shown. In this instance, an analyzed passage included annotation 1 202, annotation 2 204, annotation 3 206, and annotation 4 208. Annotations 1 2, 3, and 4 202 204 206 208 were analyzed using a neural network 210 and a logical regression model 212. As illustrated, the mechanism for analyzing the annotations results in a different ranking of annotations. The neural network 210 considers annotation 1 202 as the highest ranked annotation. On the other hand, the logical regression model 212 considers annotation 4 208 as the highest ranked annotation.

Referring to FIG. 2B, a pairwise matrix 214 using the rankings determined by the neural network 210 is illustrated. The pairwise matrix 214 represents a relative position of each annotation. Each row of the pairwise matrix 214 represents the ranking of the annotation described in the first column in relation to the other annotations. Each “0” represents that the annotation described in the row is of an equal or lesser ranking than a corresponding annotation described in a column. Each “1” represents that the annotation described in the row is of a greater ranking than a corresponding annotation described in a column. For example, the annotation 1 row illustrates that annotation 1 202 has a greater ranking that annotation 2 204, annotation 3 206, and annotation 4 208.

The scoring unit 106 reduces the dimensions of the matrix using various mathematical techniques. In one embodiment of the present invention, singular value decomposition. As illustrated in FIG. 2B, the pairwise matrix 214 has sixteen dimensions. Through decomposition the scoring unit 106 can reduce the dimensions of the pairwise matrix 214 to less than sixteen dimensions.

The communication network 110 can include a server 50. The server 50 can communicate via any appropriate technology include the internet, fiber optics, microwave, xDSL (Digital Subscriber Line), Wireless Local Area Network (WLAN) technology, satellite, wireless cellular technology, Bluetooth technology and/or any other appropriate communication technology.

The phrases “neural network” and “machine learning” broadly describes a function of electronic systems that learn from data. A machine learning system, engine, or module can include a machine learning algorithm that can be trained, such as in an external cloud environment (e.g., the cloud computing environment 50), to learn functional relationships between inputs and outputs that are currently unknown. In one or more embodiments, machine learning functionality can be implemented using a scoring unit 106 having the capability to be trained to perform a currently unknown function. In machine learning and cognitive science, neural networks are a family of statistical learning models inspired by the biological neural networks of animals, and in particular, the brain. Neural networks can be used to estimate or approximate systems and functions that depend on a large number of inputs.

The scoring unit 106 can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in the scoring unit 106 that carry electronic messages between simulated neurons are provided with numeric weights that correspond to the strength or weakness of a given connection. During training, The weights can be adjusted and tuned based on experience, making the scoring unit 106 adaptive to inputs and capable of learning. After being weighted and transformed by a function determined by the network's designer, the activation of these input neurons are then passed to other downstream neurons, which are often referred to as “hidden” neurons. This process is repeated until an output neuron is activated. The activated output neuron determines which character was read.

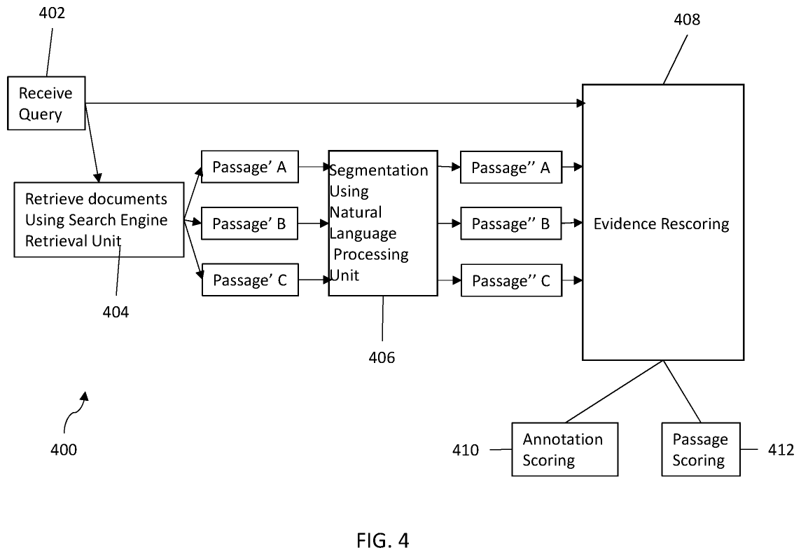

Referring to FIG. 4, a process flow 400 for passage approximation is shown. At block 402, an information retrieval system receives a search query from a user. The search query can be entered by a user through a user computing device and transmitted to the information retrieval system via the internet. At block 404, the information retrieval system searches a database, corpus, and/or knowledge base for candidate documents to answer the search query. The information retrieval system can apply natural language processing techniques to analyze the search query to determine the type of question and the information sought. This process includes analyzing keywords and semantic construction of the search query. As illustrated in FIG. 4, the information retrieval system has retrieved one document with three passages. However, it should be appreciated that the information retrieval system can retrieve multiple documents each having multiple passages. At block 406, the information retrieval system applies natural language processing techniques to segment the document into passages. The information retrieval system further analyzes any keywords and semantic construction of the passages to separate the documents into individual passages. Passages can be paragraphs, sentences, or other units. At block 408, the information retrieval system uses machine learning algorithms for scoring the annotations 410 and scoring the passages 412. The information retrieval system then uses the scores to generate respective rankings for the passages and annotations. The information retrieval system then uses the annotation rankings to generate a pairwise matrix. The pairwise matrix represents a relative ranking position of each annotation to each other annotation. The information retrieval system then reduces the dimensions of the pairwise matrix using a decomposition method. In one instance, the information retrieval system uses a singular value decomposition method, which decomposes the pairwise matrix into three matrixes U D, and V, in which the columns of the U and V matrixes are orthonormal, and the columns of the D matrix are diagonal with positive real entries. This reduces the overall size of the pairwise matrix and simplifies computation. The information retrieval system extracts values from the decomposed matrixes to rank the passages with respect to the annotations and in relation to the search query. The information retrieval system ranks the passages and returns the k-highest ranked passages to the user.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

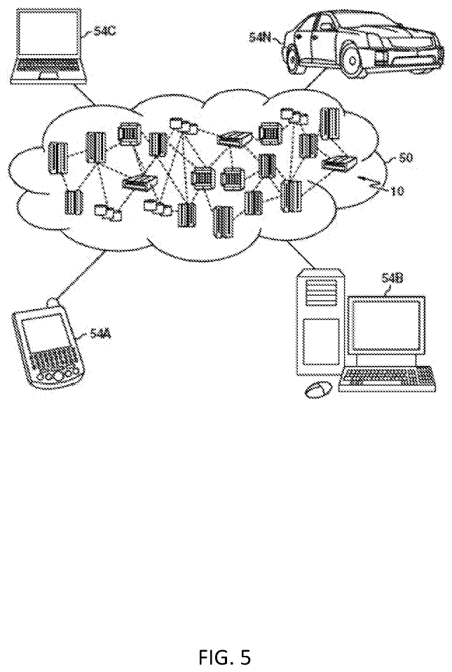

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

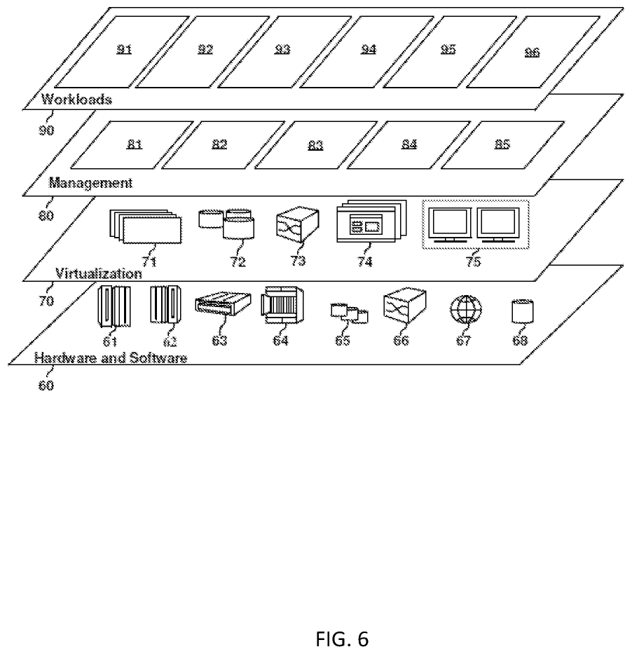

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and relevance approximation of passage evidence 96.

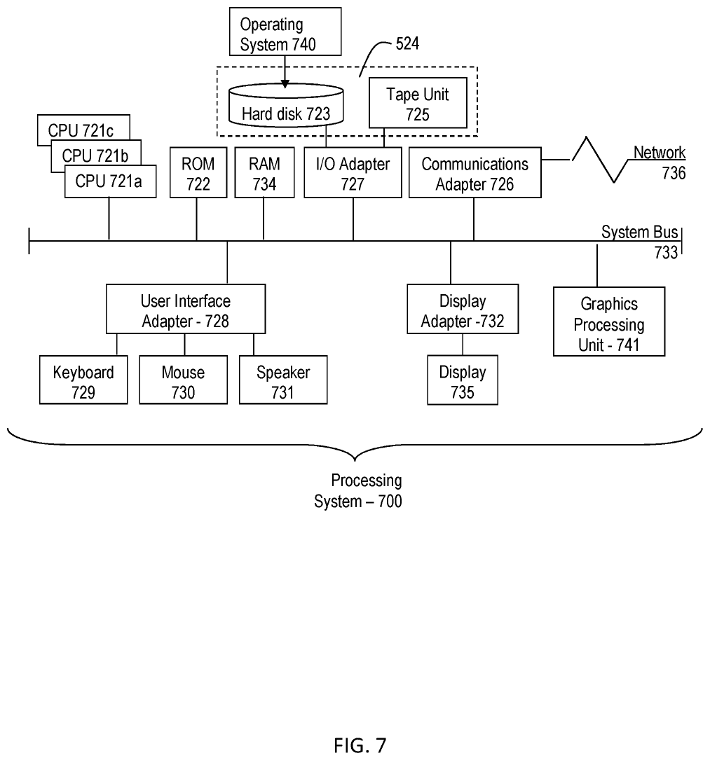

It is understood that the present disclosure is capable of being implemented in conjunction with any other type of computing environment now known or later developed. For example, FIG. 7 depicts a block diagram of a processing system 700 for implementing the techniques described herein. In examples, the processing system 700 has one or more central processing units (processors) 721a, 721b, 721c, etc. (collectively or generically referred to as processor(s) 721 and/or as processing device(s)). In aspects of the present disclosure, each processor 721 can include a reduced instruction set computer (RISC) microprocessor. Processors 721 are coupled to system memory (e.g., random access memory (RAM) 724) and various other components via a system bus 733. Read only memory (ROM) 722 is coupled to system bus 733 and may include a basic input/output system (BIOS), which controls certain basic functions of the processing system 700.

Further depicted are an input/output (I/O) adapter 727 and a network adapter 726 coupled to the system bus 733. I/O adapter 727 may be a small computer system interface (SCSI) adapter that communicates with a hard disk 723 and/or a storage device 725 or any other similar component. I/O adapter 727, hard disk 723, and storage device 725 are collectively referred to herein as mass storage 734. Operating system 740 for execution on processing system 700 may be stored in mass storage 734. The network adapter 726 interconnects system bus 733 with an outside network 736 enabling processing system 700 to communicate with other such systems.

A display (e.g., a display monitor) 735 is connected to the system bus 733 by display adapter 732, which may include a graphics adapter to improve the performance of graphics intensive applications and a video controller. In one aspect of the present disclosure, adapters 726, 727, and/or 732 may be connected to one or more I/O busses that are connected to the system bus 733 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 733 via user interface adapter 728 and display adapter 732. An input device 729 (e.g., a keyboard, a microphone, a touchscreen, etc.), an input pointer 730 (e.g., a mouse, trackpad, touchscreen, etc.), and/or a speaker 731 may be interconnected to system bus 733 via user interface adapter 728, which may include, for example, a Super I/O chip integrating multiple device adapters into a single integrated circuit

In some aspects of the present disclosure, the processing system 700 includes a graphics processing unit 737. Graphics processing unit 737 is a specialized electronic circuit designed to manipulate and alter memory to accelerate the creation of images in a frame buffer intended for output to a display. In general, graphics processing unit 737 is very efficient at manipulating computer graphics and image processing and has a highly parallel structure that makes it more effective than general-purpose CPUs for algorithms where processing of large blocks of data is done in parallel.

Thus, as configured herein, the processing system 700 includes processing capability in the form of processors 721, storage capability including system memory (e.g., RAM 724), and mass storage 734, input means such as keyboard 729 and mouse 730, and output capability including speaker 731 and display 735. In some aspects of the present disclosure, a portion of system memory (e.g., RAM 724) and mass storage 734 collectively store the operating system 740 to coordinate the functions of the various components shown in the processing system 700.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processor, a search query from a user computing device;
retrieving, by the processor, a set of passages based on the search query, wherein each passage contains passage evidence and an annotation embedded as metadata;
scoring, by the processor, each annotation and each passage evidence, wherein each annotation score is based on a feature vector of the annotation and the search query, and wherein each passage evidence score is based on a feature vector of the passage evidence and the search query;
ranking, by the processor, each passage based on a passage evidence score and a score of one annotation contained in the passage; and
returning, by the processor, a ranked list of each passage to the user computing device.

2. The computer-implemented method of claim 1 further comprising generating a pairwise matrix representing a ranking of each annotation of a passage in relation to each other annotation, wherein the ranking is based at least in part of the type of machine learning model used to generate the annotation score.

3. The computer-implemented method of claim 2 further comprising reducing a total number of dimensions of the pairwise matrix by decomposition of the pairwise matrix.

4. The computer-implemented method of claim 3 further comprising ranking the passages based at least in part on the pairwise matrix with reduced number of dimensions.

5. The computer-implemented method of claim 1 further comprising:
retrieving a set of documents from the database; and
segmenting the documents into passages via natural language processing techniques.

6. The computer-implemented method of claim 1, wherein the ranked list comprises the passages having k-highest scores.

7. The computer-implemented method of claim 1, wherein the database comprises a medical corpus.

8. A system comprising:
a memory having computer readable instructions; and
one or more processors for executing the computer readable instructions, the computer readable instructions controlling the one or more processors to perform operations comprising:
receiving a search query from a user computing device;
retrieving a set of passages based on the search query, wherein each passage contains passage evidence and an annotation embedded as metadata;
scoring each annotation and each passage evidence, wherein each annotation score is based on a feature vector of the annotation and the search query, and wherein each passage evidence score is based on a feature vector of the passage evidence and the search query;
ranking each passage based on a passage evidence score and a score of one annotation contained in the passage; and
returning a ranked list of each passage to the user computing device.

9. The system of claim 8, wherein the operations further comprise generating a pairwise matrix representing a ranking of each annotation of a passage in relation to each other annotation, wherein the ranking is based at least in part of the type of machine learning model used to generate the annotation score.

10. The system of claim 9, wherein the operations further comprise reducing a total number of dimensions of the pairwise matrix by decomposition of the pairwise matrix.

11. The system of claim 10, wherein the operations further comprise ranking the passages based at least in part on the pairwise matrix with reduced number of dimensions

12. The system of claim 11, wherein the operations further comprise:
retrieving a set of documents from the database; and
segmenting the documents into passages via natural language processing techniques.

13. The system of claim 8, wherein the ranked list comprises the passages having k-highest scores.

14. The system of claim 8, wherein the database comprises a medical corpus.

15. A computer program product comprising a computer readable storage medium having program instructions embodied therewith, the program instructions executable by a processor to cause the processor to perform operations comprising:
receiving a search query from a user computing device;
retrieving a set of passages based on the search query, wherein each passage contains passage evidence and an annotation embedded as metadata;
scoring each annotation and each passage evidence, wherein each annotation score is based on a feature vector of the annotation and the search query, and wherein each passage evidence score is based on a feature vector of the passage evidence and the search query;
ranking each passage based on a passage evidence score and a score of one annotation contained in the passage; and
returning a ranked list of each passage to the user computing device.

16. The computer-program product of claim 15, wherein the operations further comprise generating a pairwise matrix representing a ranking of each annotation of a passage in relation to each other annotation, wherein the ranking is based at least in part of the type of machine learning model used to generate the annotation score.

17. The computer-program product of claim 16, wherein the operations further comprise reducing a total number of dimensions of the pairwise matrix by decomposition of the matrix.

18. The computer-program product of claim 17, wherein the operations further comprise:
ranking the passages based at least in part on the pairwise matrix with reduced number of dimensions.

19. The computer program product of claim 15, wherein the operations further comprise:
retrieving a set of documents from the database; and
segmenting the documents into passages via natural language processing techniques.

20. The computer program product of claim 15, wherein the ranked list comprises the passages having k-highest scores.
